(19) United States
(12) Patent Application Publication
(10) Pub. No.: US 2005/0170829 A1
(43) Pub. Date: Aug. 4, 2005

(54) Method for remotely controlling at least one unmanned machine employing session initiation protocol (SIP)

(75) Inventor: Sang-Uk Seo, Buk-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/028,663

(22) Filed: Jan. 5, 2005

(30) Foreign Application Priority Data
Feb. 2, 2004 (KR) 2004-6659

(51) Int. Cl. H04M 3/00

(52) U.S. Cl. 455/420; 340/7.2; 709/227

(57) ABSTRACT

In a method for controlling at least one remote unmanned machine by means of a mobile terminal using a Session Initiation Protocol (SIP) through an SIP server are provided. A session is established between the mobile terminal and the at least one remote unmanned machine through the SIP server. A command message and a response message corresponding thereto are exchanged between the mobile terminal and the at least one remote unmanned machine through the established session, and the at least one remote unmanned machine is controlled and monitored. A command message for terminating an operation for controlling and monitoring the at least one remote unmanned machine is sent to the at least one remote unmanned machine, and the session is terminated.

### PRIORITY

This application claims the benefit under 35 U.S.C. 119(a) of an application entitled “METHOD FOR REMOTELY CONTROLLING AT LEAST ONE UNMANNED MACHINE”, filed in the Korean Intellectual Property Office on Feb. 2, 2004 and assigned Serial No. 2004-6659, the entire contents of which are incorporated herein by reference.

### BACKGROUND OF THE INVENTION

1. Field of the Invention

The present invention relates generally to a method for remotely controlling at least one unmanned machine. More particularly, the present invention relates to a method that can remotely control at least one unmanned machine by communicating with the unmanned machine using a messenger function based on a Session Initiation Protocol (SIP).

2. Description of the Related Art

Generally, unmanned machines include vending or slot machines, parking meters, home automation or remote building management systems, etc. These unmanned machines operate by themselves, but a manager must personally go to and inspect the machines when they need to be inspected.

For example, even when there remain enough drink cans in a vending machine, the manager must go to the vending machine and check if sufficient cans remain, because the manager does not know how many cans are left in the vending machine.

Even when no drinks are left in the vending machine, the manager may not realize that the vending machine is empty and thus may not refill the empty vending machine or check on the vending machine.

Accordingly, to address these problems, one method monitors a machine by means of a Short Messaging Service (SMS) between an unmanned machine mounted with a wireless modem and a mobile terminal receiving an SMS message that is now commonly used by an increasing number of users. When using the SMS, a manager of the unmanned machine does not need to go to and check the machine.

However, there is a problem in that the conventional SMS method for checking a state of the unmanned machine cannot monitor a plurality of machines in real-time. Moreover, there is another problem in that the conventional SMS method takes a relatively long time to transmit and receive information through the SMS.

Further, there are other problems in that frequently an SMS message is not accurately communicated due to an incomplete technical specification, and the conventional SMS method has many limitations in terms of its scalability.

### SUMMARY OF THE INVENTION

Accordingly, the present invention has been designed to solve the above and other problems occurring in the prior art. Therefore, it is an object of the present invention to provide a method that remotely controls at least one unmanned machine by communicating with the unmanned machine using a messenger function or an Instant Message (IM) based on a Session Initiation Protocol (SIP).

It is another object of the present invention to provide a method for remotely controlling at least one unmanned machine that monitors and manages a plurality of unmanned machines.

In accordance with an aspect of the present invention, the above and other objects can be accomplished by a method for controlling at least one remote unmanned machine by means of a mobile terminal using a Session Initiation Protocol (SIP) through an SIP server, comprising: establishing a session between the mobile terminal and the at least one remote unmanned machine through the SIP server; exchanging a command message and a response message corresponding thereto between the mobile terminal and the at least one remote unmanned machine through the established session, and controlling and monitoring the at least one remote unmanned machine; and sending, to the at least one remote unmanned machine, a command message for terminating an operation for controlling and monitoring the at least one remote unmanned machine, and terminating the session.

In accordance with another aspect of the present invention, the above and other objects can be accomplished by a method for controlling at least one remote unmanned machine by means of a mobile terminal using a Session Initiation Protocol (SIP) through an SIP server, comprising generating a data call at a time set by a manager, and sending a session setup request via the at least one remote unmanned machine; receiving, from the SIP server, a response to the session setup request, and establishing a session; sending, to the SIP server, a request for participation in the established session through the mobile terminal, receiving a response to the request, and participating in the session; exchanging a command message and a response message corresponding thereto between the mobile terminal and the at least one remote unmanned machine participating in the session, and controlling and monitoring the at least one remote unmanned machine; and sending, to the at least one remote unmanned machine, a command message for terminating an operation for controlling and monitoring the at least one remote unmanned machine, and terminating the session.

In accordance with another aspect of the present invention, the above and other objects can be accomplished by a method for controlling at least one remote unmanned machine by means of a mobile terminal using a Session Initiation Protocol (SIP) through an SIP server, comprising: sending a voice call to the at least one remote unmanned machine through the mobile terminal; checking a call number of the mobile terminal, generating a data call, and sending a session setup request to the SIP server; receiving, from the SIP server, a response to the session setup request, and establishing a session; sending, to the SIP server, a request for participation in the established session through the mobile terminal, receiving a response to the request, and participating in the session; exchanging a command message and a response message corresponding thereto between the mobile terminal and the at least one remote unmanned machine participating in the session, and controlling and monitoring the at least one remote unmanned machine; and sending, to the at least one remote unmanned machine, a command message for terminating an operation for controlling and monitoring the at least one remote unmanned machine, and terminating the session.

In accordance with yet another aspect of the present invention, the above and other objects can be accomplished by a method for controlling at least one remote unmanned machine by means of a mobile terminal using a Session Initiation Protocol (SIP) through an SIP server, comprising: immediately after a power supply of the at least one remote unmanned machine is turned on, generating a data call, and sending a session setup request; receiving, from the SIP server, a response to the session setup request, and establishing a session; sending, to the SIP server, a request for participation in the established session through the mobile terminal, receiving a response to the request, and participating in the session; exchanging a command message and a response message corresponding thereto between the mobile terminal and the at least one remote unmanned machine participating in the session, and controlling and monitoring the at least one remote unmanned machine; and sending, to the at least one remote unmanned machine, a command message for terminating an operation for controlling and monitoring the at least one remote unmanned machine, and terminating the session.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a mobile terminal in accordance with an embodiment of the present invention;

FIG. 2 illustrates an example of a process for controlling a remote unmanned machine by means of the mobile terminal in accordance with an embodiment of the present invention;

FIG. 3 is a flow chart illustrating a method for remotely controlling the unmanned machine in accordance with a first embodiment of the present invention;

FIG. 4 illustrates the format of a command/response message exchanged between the mobile terminal and the remote unmanned machine when the unmanned machine is remotely controlled in accordance with the present invention;

FIG. 5 illustrates an example of a process in which the mobile terminal remotely monitors and controls the remote unmanned machine by means of the command/response message illustrated in FIG. 4;

FIG. 6 is a flow chart illustrating the method for remotely controlling the unmanned machine in accordance with a second embodiment of the present invention; and

FIG. 7 is a flow chart illustrating the method for remotely controlling the unmanned machine in accordance with a third embodiment of the present invention.

### DETAILED DESCRIPTION OF THE PREFERRED EMBODIMENTS

Embodiments of the present invention will now be described in detail herein below with reference to the accompanying drawings.

In the following description, a detailed description of known functions and configurations incorporated herein will be omitted for conciseness.

In the following description, a Session Initiation Protocol (SIP) can provide E-mail, Instant Messages (IMs), and so on as well as a voice communication service using the same identifier as in an E-mail address system. The SIP can establish, modify, and terminate multimedia sessions or calls with one or more participants. These multimedia sessions include multimedia conferences, remote learning, Internet telephone calls, and similar applications. When a multimedia session is established, services are provided according to user capability and availability indicated by session parameters of a body field in an SIP message including header and body fields. A SIP user can register a mobile phone number, an office phone number, a home phone number, and an E-mail address, and so on in an SIP server, and can store process contents associated with all calls in the SIP server. For example, a messenger enables conferences or voice chatting using the SIP. Embodiments of the present invention can remotely control and monitor at least one remote unmanned machine participating in a session by means of a mobile terminal participating in the session.

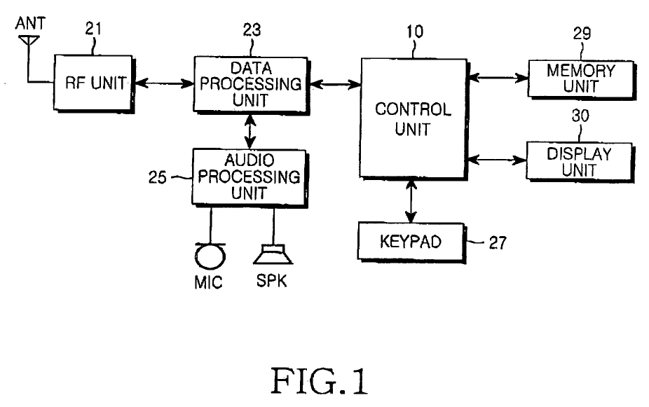

FIG. 1 is a block diagram illustrating a mobile terminal in accordance with an embodiment of the present invention.

Referring to FIG. 1, a Radio Frequency (RF) unit 21 performs a communication function of the mobile terminal. The RF unit 21 includes an RF transmitter (not shown) for up converting and amplifying a frequency of a signal to be transmitted, and an RF receiver (not shown) for low-noise amplifying a received signal and down converting a frequency of the received signal.

A data processing unit 23 includes a transmitter (not shown) for coding and modulating the signal to be transmitted and a receiver (not shown) for demodulating and decoding the received signal. That is, the data processing unit 23 can comprise a modulator-demodulator (MODEM) and a coder-decoder (CODEC). More specifically, the data processing unit 23 sends a voice call for monitoring and controlling an unmanned machine and exchanges a message with the remote unmanned machine using the SIP in accordance with the embodiment of the present invention.

An audio processing unit 25 performs a function for reproducing a received audio signal output from the data processing unit 23 or outputting a transmission audio signal generated from a microphone (MIC) to the data processing unit 23. Moreover, the audio processing unit 25 converts voice data among data received from the data processing unit 23 into an audible sound, and then outputs the audible sound through a speaker (SPK). Further, the audio processing unit 25 converts an input voice signal into data, and then outputs the data to the data processing unit 23. In accordance with the embodiment of the present invention, the audio processing unit 25 can output notice sound through the speaker (SPK) in response to a response message received from the remote unmanned machine.

A keypad 27 includes keys necessary for inputting number and letter information and function keys necessary for setting various functions. More specifically, the keypad 27 can include a remote key serving as a shortcut key for generating a data call capable of establishing a messenger session using the SIP in accordance with the embodiment of the present invention.

A memory unit 29 can comprise program and data memories, and the like. The program memory can store programs for controlling general operations of the mobile terminal, and programs for monitoring and controlling the unmanned machine using a messenger function through the SIP in accordance with the embodiment of the present invention. The data memory performs a function for temporarily storing data generated while the programs are executed.

A control unit 10 performs a function for controlling overall operation of the mobile terminal. Alternatively, the control unit 110 can include the data processing unit 23. More specifically, the control unit 10 controls overall an operation to monitor and control the unmanned machine using the messenger function through the SIP in accordance with the embodiment of the present invention.

The display unit 30 displays messages generated while a program is executed under control of the control unit 10. More specifically, the display unit 30 can display a message of a response to a command for monitoring or controlling the unmanned machine when the unmanned machine is monitored or controlled in accordance with the embodiment of the present invention. Here, the display unit 30 can be a Liquid Crystal Display (LCD). In case of the LCD, the display unit 30 can include an LCD controller, a memory capable of storing image data, an LCD element, etc. When the LCD is implemented using a touch-screen system, the keypad 27 and the LCD can serve as an input unit.

Operation of the mobile terminal will be described with reference to FIG. 1. When a user sets a signal transmission mode after a dialing operation through the keypad 27, the control unit 10 detects the set signal transmission mode, controls the data processing unit 23 to process received dial information, and controls the RF unit 21 to convert the processed information into an RF signal and output the RF signal. Subsequently, when a receiving subscriber generates a response signal, the control unit 10 detects the response signal through the RF unit 21 and the data processing unit 23. The user performs a communication function by means of a voice communication path established through the audio processing unit 25. On the other hand, when a signal reception mode is performed, the control unit 10 detects the signal reception mode through the data processing unit 23 and controls the audio processing unit 25 to generate a ringtone. Subsequently, when the user responds, the control unit 10 detects the response. The user performs a communication function by means of a voice communication path established through the audio processing unit 25. Although an example of voice communication in the signal transmission and reception modes has been described above, a data communication function for communicating packet data and image data other than the voice communication can be performed. When an idle mode or character or text communication is entered/performed, the control unit 10 controls the display unit 30 to display character or text data processed by the data processing unit 23.

A process for remotely controlling the unmanned machine by means of the above-described mobile terminal will now be described. The control unit 10 determines if the remote key of the keypad 27 has been input. If the remote key of the keypad 27 has been input, the control unit 10 sends a voice call to the remote unmanned machine to be remotely monitored and controlled. When the unmanned machine sends a session setup request to the SIP server at a time set by a manager, the mobile terminal can participate in a session through the SIP server. Through the above-described process, the control unit 10 of the mobile terminal participating in the session sends a text-based command input from the keypad 27 to the remote unmanned machine through the data processing unit 23. After receiving a message of a response to the command through the data processing unit 23, the control unit 10 controls the display unit 30 to display the response message. At this point, the display unit 30 can display the response message to the command and the speaker (SPK) can output a sound based on the response message.

A process for controlling and monitoring the remote unmanned machine by means of the mobile terminal through a data exchange operation between the mobile terminal and the remote unmanned machine will now be described with reference to the accompanying drawings.

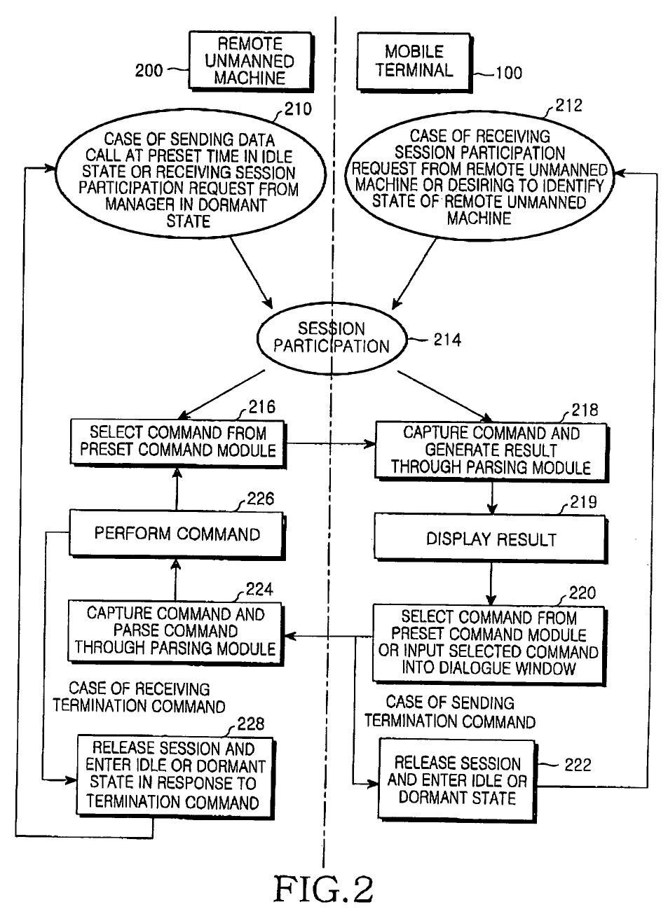

FIG. 2 illustrates an example of a process for controlling the remote unmanned machine by means of the mobile terminal in accordance with an embodiment of the present invention.

Referring to FIG. 2, the mobile terminal 100 participates in a session when receiving a session participation request from the remote unmanned machine 200 or desiring to identify a state of the remote unmanned machine 200. At this point, the remote unmanned machine 200 receives the session participation request in a dormant state and then participates in the session.

The remote unmanned machine 200 sends a data call at a preset time in an idle state in step 210. After the remote unmanned machine 200 sends the data call, the mobile terminal 100 sends a session participation request at the preset time in step 212. The remote unmanned machine 200 and the mobile terminal 100 engage in the session participation in step 214.

Through the above-described process, the mobile terminal 100 participating in the session sends a command for monitoring or a command for controlling to the remote unmanned machine 200. The command is a command preset in the mobile terminal 100 or a command message input into a dialogue window when a user directly manipulates keys of the keypad 27. The mobile terminal 100 and the remote unmanned machine 200 exchange the command and a response thereto in steps 216 and 218. The mobile terminal 100 receiving the response displays a response message on the display unit 30 in step 219.

Subsequently, if the mobile terminal 100 completes an operation for remotely monitoring and controlling the remote unmanned machine 200, it sends a termination command to the remote unmanned machine 200 in steps 220 and 222. The remote unmanned machine 200 receiving the termination command releases the session according to the termination command, and enters the idle or dormant state in steps 224, 226 and 228.

The method for remotely controlling the unmanned machine will be described in detail.

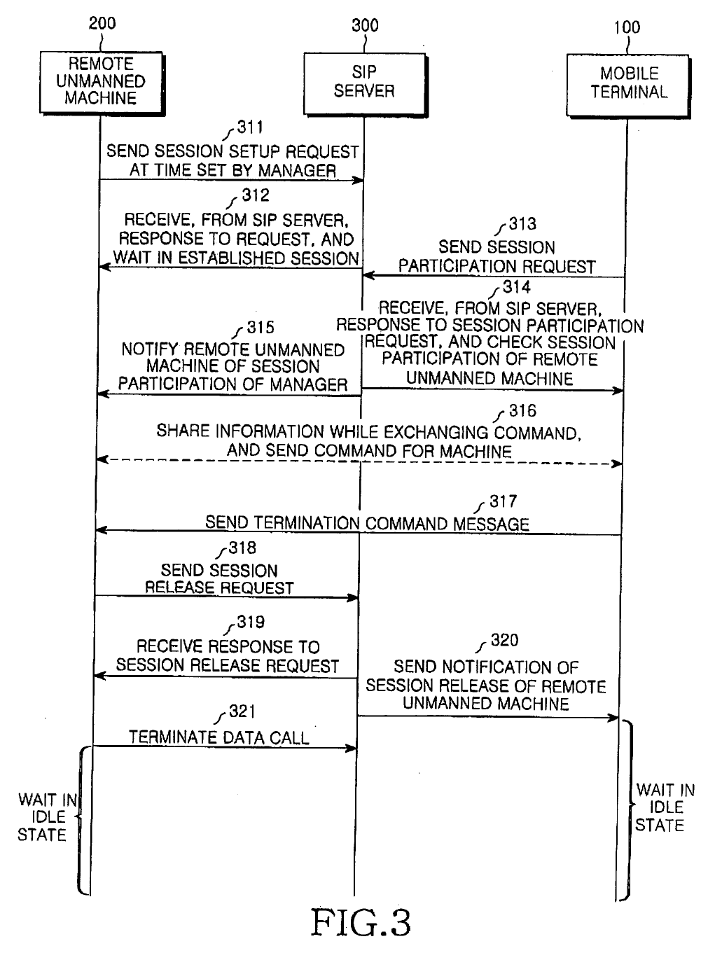

FIG. 3 is a flow chart illustrating the method for remotely controlling the unmanned machine in accordance with a first embodiment of the present invention.

Additionally, FIG. 3 illustrates the case where the remote unmanned machine 200 first establishes a session at a time set by the manager under the assumption that the remote unmanned machine 200 is assigned one temporarily available Internet Protocol (IP) address when attempting a data call.

Referring to FIG. 3, the remote unmanned machine 200 sends, to a SIP server 300, a session setup request at the time set by the manager in step 311. Then, the SIP server 300 sends a response to the session setup request to the remote unmanned machine 200. In step 312, the remote unmanned machine 200 waits for the manager to participate in the session, after receiving the response from the SIP server 300.

In step 313, the manager sends, to the SIP server 300, a request for participation in the session established by the remote unmanned machine 200 because the manager is aware of the session setup time. Then, the SIP server 300 sends a response to the session participation request to the mobile terminal 100 of the manager. In step 314, the mobile terminal 100 receives, from the SIP server 300, the response to the session participation request (based on the session established by the remote unmanned machine 200) and then checks session participation of the remote unmanned machine 200. In step 315, the SIP server 300 notifies the remote unmanned machine 200 of the session participation of the mobile terminal 100.

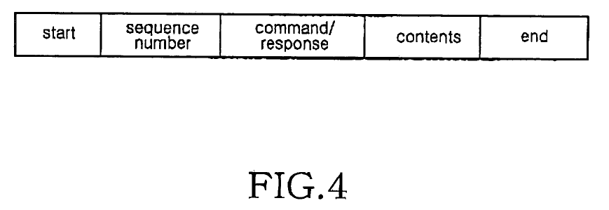

Subsequently, in step 316, the manager sends a command message for remotely controlling the remote unmanned machine 200 by means of the mobile terminal 100, and the remote unmanned machine 200 sends, to the mobile terminal 100, a response message to the command message. Further, the remote unmanned machine 200 sends a command message to the mobile terminal 100, and the mobile terminal 100 sends, to the remote unmanned machine 200, a response message to the command message. Here, the format of the command or response message is the same as that of the message illustrated in FIG. 4.

Referring to FIG. 4, the command message includes a start field indicating the beginning of the command message, a sequence number field indicating a sequence number of the message, a command field indicating a command for an operation to be performed, and an end field indicating the end of the command message. On the other hand, the response message includes a start field indicating the beginning of the response message, a sequence number field indicating a sequence number of the message, a response field indicating the response message to a command message, a content field indicating a result or content according to the command message, and an end field indicating the end of the response message. A field of the command or response message can be added or deleted, if required. The command message can be defined according to types or characteristics of remote unmanned machine, or content to be identified. Basically, the response message to the command message can be transmitted using the same start and sequence number fields as those of the command message. This is to distinguish a response message to a certain command message.

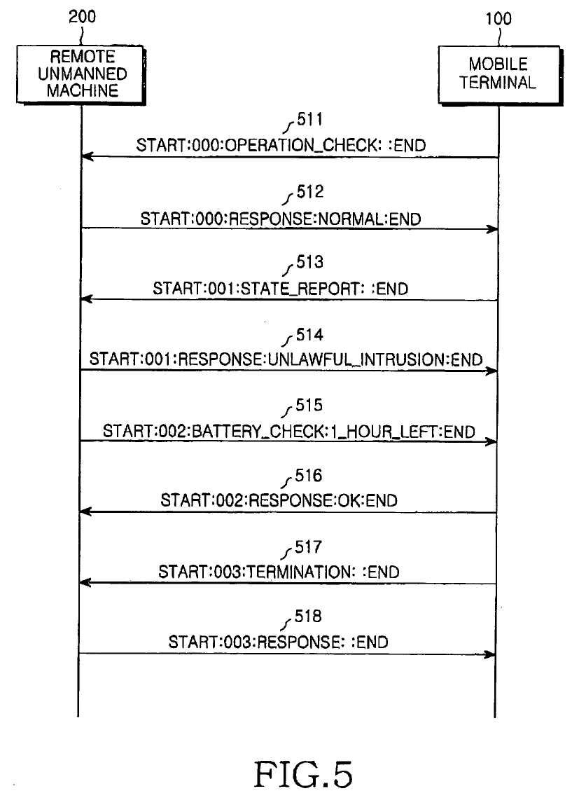

FIG. 5 illustrates an example of a process in which the mobile terminal 100 remotely monitors and controls the remote unmanned machine 200 by means of the command/response message illustrated in FIG. 4.

Referring to FIGS. 3 and 5, when the mobile terminal 100 sends a command message of “start:000:operation_check::end” to check an operation of the remote unmanned machine 200 in step 511, the remote unmanned machine 200 sends a response message of “start:000:response:normal:end” to the mobile terminal 100 in step 512. At this point, if the remote unmanned machine 200 is abnormal, the content field of the response message includes content indicating “abnormal” in place of “normal”.

When the mobile terminal 100 sends, to the remote unmanned machine 200, a command message of “start:001:state_report::end” to determine a state of the remote unmanned machine 200 in step 513, the remote unmanned machine 200 reports its own state by sending a response message of, for example, “start:001:response:unlawful_intrusion:end”, to the mobile terminal 100 in step 514. At this point, the content field of the response message can include other content in place of “unlawful_intrusion” according to a state of the remote unmanned machine 200.

When the remote unmanned machine 200 sends, to the mobile terminal 100, a command message of “start:002:battery_check:1_hour_left:end” before a predetermined time set by the manager to monitor the remote unmanned machine 200 in step 515, the mobile terminal 100 sends a response message of “start:002:response:ok:end” to the remote unmanned machine 200 in step 516.

Referring to FIG. 3, in step 316, the mobile terminal 100 can monitor and control the remote unmanned machine 200 using the message illustrated in FIG. 4 through the process illustrated in FIG. 5.

Subsequently, the manager inputs the END key provided in the keypad 27 of the mobile terminal 100 to terminate the process for monitoring and controlling the remote unmanned machine 200 using the mobile terminal 100. The mobile terminal 100 sends a termination command message to the remote unmanned machine 200 in step 317. Subsequently, the remote unmanned machine 200 sends a session release request to the SIP server 300 in step 318.

Subsequently, the SIP server 300 sends, to the remote unmanned machine 200, a response to the session release request, and the remote unmanned machine 200 receives the response to the session release request in step 319. In step 320, the SIP server 300 notifies the mobile terminal 100 of the session release of the remote unmanned machine 200, and the mobile terminal 100 receiving the session release notification enters the idle state. Then, the remote unmanned machine 200 enters the idle state after terminating the data call in step 321.

Referring again to FIG. 5, in step 517, the mobile terminal 100 sends a command message of “start:003:termination::end” to the remote unmanned machine 200 when terminating the operation for monitoring and controlling the remote unmanned machine 200. The remote unmanned machine 200 receiving the command message sends, to the mobile terminal 100, a response message of “start:003:response::end” to the command message in step 518.

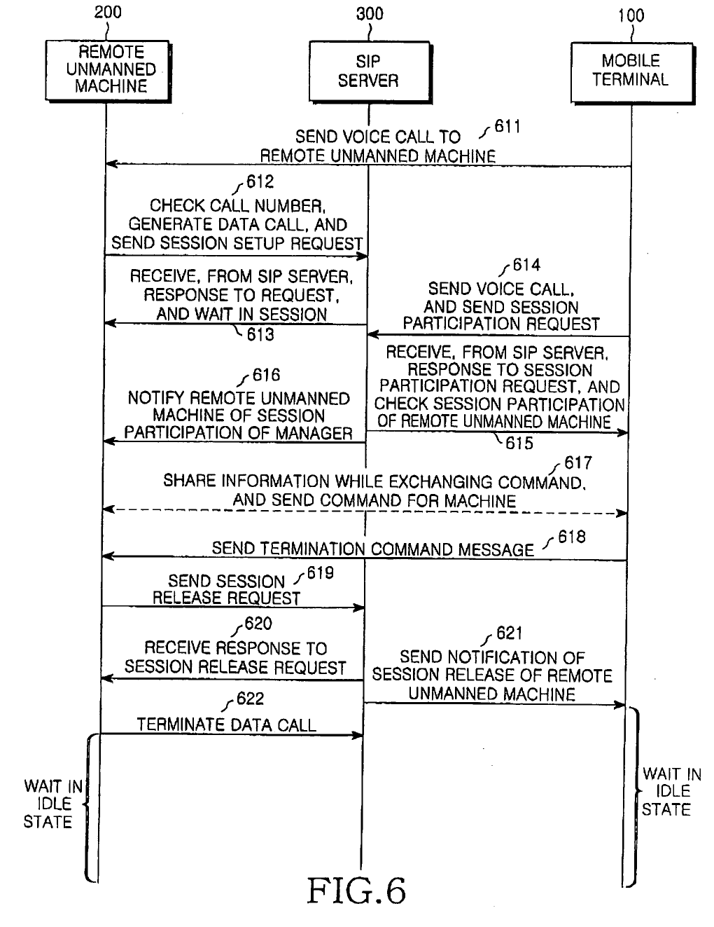

FIG. 6 is a flow chart illustrating a method for remotely controlling the unmanned machine in accordance with a second embodiment of the present invention.

Additionally, FIG. 6 illustrates the case where the manager sends a voice call to the remote unmanned machine through the mobile terminal 100 to first establish a session.

Referring to FIG. 6, the manager sends the voice call to the remote unmanned machine 200 to be remotely controlled and monitored through the mobile terminal 100 in step 611. Then, after checking a call number of the voice call and terminating the voice call, the remote unmanned machine 200 sends a session setup request to the SIP server 300 through a data call in step 612. The remote unmanned machine 200 receives, from the SIP server 300, a response to the request and then waits during the established session in step 613. Here, the remote unmanned machine 200 checks the call number of the manager and sends an Outgoing Message (OGM) according to a result of the checking.

In step 614, the manager sends a session participation request to the SIP server 300 after sending the voice call by means of the mobile terminal 100, and the SIP server 300 allows the mobile terminal to participate in a session in response to the request. In step 615, the manager checks the session participation of the remote unmanned machine 200 by means of the mobile terminal 100. Subsequently, in step 616, the SIP server 300 notifies the remote unmanned machine 200 of the session participation of the manager. Then, the manager sends, to the remote unmanned machine 200, a command message for remotely controlling the remote unmanned machine 200 by means of the mobile terminal 100, and the remote unmanned machine 200 sends, to the mobile terminal 100, a response message to the command message in step 617. Further, the remote unmanned machine 200 sends a command message to the mobile terminal 100, and the mobile terminal 100 sends, to the remote unmanned machine 200, a response message to the command message. Here, the format of the command or response message is the same as that of the message illustrated in FIG. 4, and a process for controlling and monitoring the remote unmanned machine 200 by means of the mobile terminal 100 is the same as that illustrated in FIG. 5.

Subsequently, when terminating an operation for controlling and monitoring the remote unmanned machine 200, the manager sends a session termination command message to the remote unmanned machine 200 through the mobile terminal 100 in step 618.

The remote unmanned machine 200 receiving the termination command message sends a session release request to the SIP server 300 in step 619, and receives, from the SIP server 300, a response to the session release request in step 620. Subsequently, the SIP server 300 notifies the mobile terminal of the session release of the remote unmanned machine 200 in step 621. At this point, the mobile terminal 100 receiving the notification of the session release enters the idle state. Subsequently, the remote unmanned machine 200 terminates the data call to release the session established through the data call and then enters the idle state in step 622.

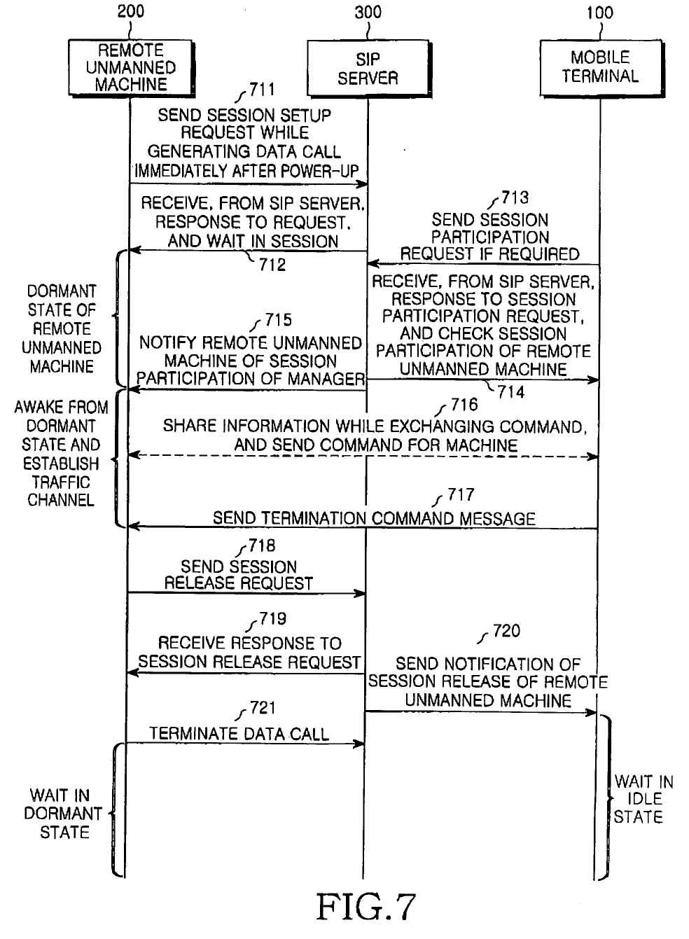

FIG. 7 is a flow chart illustrating a method for remotely controlling the unmanned machine in accordance with a third embodiment of the present invention.

Additionally, FIG. 7 illustrates the case where the remote unmanned machine 200 first establishes a session under the assumption that the remote unmanned machine 200 is assigned its own dedicated IP address, and uses the assigned IP address.

Referring to FIG. 7, the remote unmanned machine 200 sends a session setup request to the SIP server 300 while generating a data call immediately after turning on its power supply in step 711. Then, the SIP server 300 sends, to the remote unmanned machine 200, a response to the session setup request. The remote unmanned machine 200 receives, from the SIP server 300, the response to the session setup request and then enters the dormant state in step 712.

Subsequently, the manager sends a session participation request to the SIP server 300 by means of the mobile terminal 100, if required, and the SIP server 300 sends, to the mobile terminal 100, a response to the session participation request in step 713. Then, the mobile terminal 100 receives, from the SIP server 300, the response to the session participation request, and then checks the session participation of the remote unmanned machine in step 714.

Subsequently, the SIP server 300 notifies the remote unmanned machine 200 of the session participation of the manager in step 715. At this point, the remote unmanned machine 200 awakes from the dormant state in response to the notification of the session participation of the manager, and establishes a traffic channel.

Then, the manager controls and monitors the remote unmanned machine 200 by means of the mobile terminal 100 in step 716.

That is, the mobile terminal 100 sends a command message to remotely control the remote unmanned machine 200, and the remote unmanned machine 200 sends, to the mobile terminal 100, a response message to the command message. Further, the remote unmanned machine 200 sends a command message to the mobile terminal 100, and the mobile terminal 100 sends, to the remote unmanned machine 200, a response message to the command message. Here, the format of the command or response message is the same as that of the message illustrated in FIG. 4, and a process for controlling and monitoring the remote unmanned machine 200 by means of the mobile terminal 100 is the same as that illustrated in FIG. 5.

Subsequently, in steps 717 to 721, the mobile terminal 100 sends a termination command message to the remote unmanned machine 200 through the same process as that illustrated in FIG. 3 or 6 and then terminates the data call of the remote unmanned machine 200. The session for controlling and monitoring the remote unmanned machine 200 by means of the mobile terminal 100 is released. At this point, the mobile terminal 100 enters the idle state, while the remote unmanned machine 200 enters the dormant state and then waits for the mobile terminal 100 to participate in a session.

As apparent from the above description, the present invention can improve the convenience for users because a manager can remotely monitor and control a state of at least one remote unmanned machine by means of a mobile terminal and an SIP messenger function without personally going to and checking the unmanned machine.

Although the preferred embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

1. A method for controlling at least one remote unmanned machine by means of a mobile terminal using a Session Initiation Protocol (SIP) through an SIP server, comprising:
establishing a session between the mobile terminal and the at least one remote unmanned machine through the SIP server;
exchanging a command message and a response message corresponding thereto between the mobile terminal and the at least one remote unmanned machine through the established session, and controlling and monitoring the at least one remote unmanned machine; and
sending, to the at least one remote unmanned machine, a command message for terminating an operation for controlling and monitoring the at least one remote unmanned machine, and terminating the session.

2. A method for controlling at least one remote unmanned machine by means of a mobile terminal using a Session Initiation Protocol (SIP) through an SIP server, comprising:
generating a data call at a time set by a manager, and sending a session setup request via the at least one remote unmanned machine,;
receiving a response to the session setup request, and establishing a session via the SIP server;
sending, to the SIP server, a request for participation in the established session through the mobile terminal, receiving a response to the request, and participating in the session;
exchanging a command message and a response message corresponding thereto between the mobile terminal and the at least one remote unmanned machine participating in the session, and controlling and monitoring the at least one remote unmanned machine; and
sending, to the at least one remote unmanned machine, a command message for terminating an operation for controlling and monitoring the at least one remote unmanned machine, and terminating the session.

3. The method of claim 2, further comprising:
notifying the at least one remote unmanned machine of the session participation of the mobile terminal when the mobile terminal participates in the session.

4. The method of claim 2, wherein the terminating comprises:
receiving the termination command message, sending a session release request to the SIP server via the at least one remote unmanned machine;
receiving, from the SIP server, a response to the session release request via the at least one remote unmanned machine; and
notifying the mobile terminal of the session release of the at least one remote unmanned machine, and terminating the data call of the at least one remote unmanned machine.

5. The method of claim 2, wherein the at least one remote unmanned machine enters an idle state when the session is terminated.

6. The method of claim 2, wherein the mobile terminal enters an idle state when the session is terminated.

7. The method of claim 2, wherein the command message includes a start field indicating a beginning of the command message, a sequence number field indicating a sequence number of the message, a command field indicating a command for an operation to be performed, and an end field indicating an end of the command message.

8. The method of claim 2, wherein the response message includes a start field indicating a beginning of the response message, a sequence number field indicating a sequence number of the message, a response field indicating the response message to a command message, a content field indicating a result or content according to the command message, and an end field indicating an end of the response message.

9. A method for controlling at least one remote unmanned machine by means of a mobile terminal using a Session Initiation Protocol (SIP) through an SIP server, comprising:
sending a voice call to the at least one remote unmanned machine through the mobile terminal;
checking a call number of the mobile terminal, generating a data call, and sending a session setup request to the SIP server;
receiving, from the SIP server, a response to the session setup request, and establishing a session;
sending, to the SIP server, a request for participation in the established session through the mobile terminal, receiving a response to the request, and participating in the session;
exchanging a command message and a response message corresponding thereto between the mobile terminal and the at least one remote unmanned machine participating in the session, and controlling and monitoring the at least one remote unmanned machine; and
sending, to the at least one remote unmanned machine, a command message for terminating an operation for controlling and monitoring the at least one remote unmanned machine, and terminating the session.

10. The method of claim 9, further comprising:
notifying the at least one remote unmanned machine of the session participation of the mobile terminal when the mobile terminal participates in the session.

11. The method of claim 9, wherein the terminating comprises:
receiving the termination command message and sending a session release request to the SIP server via the at least one remote unmanned machine;
receiving, from the SIP server, a response to the session release request via the at least one remote unmanned machine; and
notifying the mobile terminal of the session release of the at least one remote unmanned machine, and terminating the data call of the at least one remote unmanned machine.

12. The method of claim 9, wherein the at least one remote unmanned machine enters an idle state when the session is terminated.

13. The method of claim 9, wherein the mobile terminal enters an idle state when the session is terminated.

14. The method of claim 9, wherein the command message includes a start field indicating a beginning of the command message, a sequence number field indicating a sequence number of the message, a command field indicating a command for an operation to be performed, and an end field indicating an end of the command message.

15. The method of claim 9, wherein the response message includes a start field indicating a beginning of the response message, a sequence number field indicating a sequence number of the message, a response field indicating the response message to a command message, a content field indicating a result or content according to the command message, and an end field indicating an end of the response message.

16. A method for controlling at least one remote unmanned machine by means of a mobile terminal using a Session Initiation Protocol (SIP) through an SIP server, comprising:
generating a data call, and sending a session setup request immediately after a power supply of the at least one remote unmanned machine is turned on;
receiving, from the SIP server, a response to the session setup request, and establishing a session;
sending, to the SIP server, a request for participation in the established session through the mobile terminal, receiving a response to the request, and participating in the session;
exchanging a command message and a response message corresponding thereto between the mobile terminal and the at least one remote unmanned machine participating in the session, and controlling and monitoring the at least one remote unmanned machine; and
sending, to the at least one remote unmanned machine, a command message for terminating an operation for controlling and monitoring the at least one remote unmanned machine, and terminating the session.

17. The method of claim 16, further comprising:
notifying the at least one remote unmanned machine of the session participation of the mobile terminal when the mobile terminal participates in the session.

18. The method of claim 16, wherein the terminating comprises:
receiving the termination command message and sending a session release request to the SIP server via the at least one remote unmanned machine;
receiving, from the SIP server, a response to the session release request via the at least one remote unmanned machine; and
notifying the mobile terminal of the session release of the at least one remote unmanned machine, and terminating the data call of the at least one remote unmanned machine.

19. The method of claim 16, wherein the at least one remote unmanned machine enters a dormant state when the session is terminated.

20. The method of claim 16, wherein the mobile terminal enters an idle state when the session is terminated.

21. The method of claim 16, wherein the command message includes a start field indicating a beginning of the command message, a sequence number field indicating a sequence number of the message, a command field indicating a command for an operation to be performed, and an end field indicating an end of the command message.

22. The method of claim 16, wherein the response message includes a start field indicating a beginning of the response message, a sequence number field indicating a sequence number of the message, a response field indicating the response message to a command message, a content field indicating a result or content according to the command message, and an end field indicating an end of the response message.

23. The method of claim 16, wherein the at least one remote unmanned machine enters a dormant state upon receiving, from the SIP server, the response to the session setup request.

24. The method of claim 16, wherein the at least one remote unmanned machine establishes a traffic channel in a dormant state upon receiving the notification of the session participation of the mobile terminal.
